(19) United States
(12) Patent Application Publication
(10) Pub. No.: US 2007/0180695 A1
(43) Pub. Date: Aug. 9, 2007

(54) Method and device for press-fitting, into storage outer tube, ceramic catalyst carrier having non-expansion mat wrapped therearound into storage outer tube

(75) Inventor: Yasuhiro Sugiyama, Tokyo (JP)

Correspondence Address: FOLEY AND LARDNER LLP;SUITE 500, 3000 K STREET NW, WASHINGTON, DC, 20007, US

(73) Assignee: Calsonic Kansei Corporation, Tokyo (JP)

(21) Appl. No.: 10/594,630

(22) PCT Filed: Jun. 30, 2005
(86) PCT No.: PCT/JP05/06188

§ 371 Date: Sep. 28, 2006

(30) Foreign Application Priority Data
Apr. 1, 2004 (JP) 2004-109335
Mar. 30, 2005 (JP) 2005-099589

(51) Int. Cl. B23P 19/02; B21D 51/16

(52) U.S. Cl. 29/890; 29/525

(57) ABSTRACT

A ceramic catalyst carrier 6 with a non-expandable mat 7 being assembled on an outer periphery thereof is, after the entire outer peripheral surface of the non-expandable mat 7 is evenly pressed in a radial direction and an contour thereof is press formed to be close to an inner diameter of an outer housing cylinder 8 constituting a part of an exhaust passage, press-fitted into the outer housing cylinder 8 by a press-fitting unit 3.

### TECHNICAL FIELD

The present invention relates to a press-fitting method and press-fitting apparatus for press-fitting a ceramic catalyst carrier with a non-expandable mat being wrapped thereon into an outer housing cylinder of a catalyst unit used in an exhaust system of a vehicle internal combustion engine or the like.

A ceramic catalyst carrier for purifying exhaust gas used in an internal combustion engine is generally configured such that, on the outer periphery of a ceramic catalyst carrier in which a catalyst is carried, a non-expandable mat as a cushion member constituted of ceramic fiber or the like is wrapped, and the ceramic catalyst carrier is housed via this non-expandable mat in a pressed state inside a cylindrical outer housing cylinder constituting a part of an exhaust passage.

Conventionally, as a press-fitting method of a ceramic catalyst carrier with a non-expandable mat being wrapped thereon, one disclosed in Japanese Patent Application Laid-open No. (TokukaiSho) 56-96110 is known. In this press-fitting method, as shown in FIG. 12 to FIG. 14, a ceramic catalyst carrier 101 with a non-expandable mat 102 being wrapped thereon is passed through a taper hole 104a which is set in the 3° to 5° range of a press-fitting guide jig 104 engaged with an upper opening end portion of an outer housing cylinder 103, thereby gradually pressing and housing the non-expandable mat 102 into the outer housing cylinder 103 in a pressed state.

### DISCLOSURE OF THE INVENTION

### Problems to be Solved by the Invention

However, in the conventional press-fitting method, the following problems occur. Specifically, when pressing the non-expandable mat 102 into the press-fitting guide jig 104, as shown in FIG. 13(a), a compressing force CF and a shearing force SF in plural directions are applied simultaneously to the non-expandable mat 102, so that the non-expandable mat 102 can be easily deformed as shown in FIG. 13(b). As a result, in the ceramic catalyst carrier 101 with the non-expandable mat 102 being wrapped thereon in a state of being fitted inside the outer housing cylinder 103, an outer periphery side portion of the non-expandable mat 102 is bent upward, as shown in FIG. 14(a), to protrude from an end surface of the ceramic catalyst carrier 101 and becomes corroded, or the non-expandable mat 102 is displaced upward with respect to the ceramic catalyst carrier 101, as shown in FIG. 14(b), so that the non-expandable mat 102 gets damaged, which decreases its retaining capability.

An object to be solved by the present invention is to provide a press-fitting method and apparatus for press-fitting a ceramic catalyst carrier with a non-expandable mat being wrapped thereon into an outer housing cylinder, which are capable of preventing problems such as displacement, damage and the like of the non-expandable mat, which may occur when press-fitting the ceramic catalyst carrier into the outer housing cylinder constituting a part of an exhaust passage.

### MEANS FOR SOLVING THE PROBLEMS

In order to solve the above-described problems, a press-fitting method for press-fitting a ceramic catalyst carrier with a non-expandable mat being wrapped thereon into an outer housing cylinder according to the present invention is characterized in that the ceramic catalyst carrier with a non-expandable mat being assembled on an outer periphery thereof is, after an entire outer peripheral surface of the non-expandable mat is evenly pressed in a radial direction and the contour of the non-expandable mat is press formed to be close to an inner diameter of the outer housing cylinder constituting a part of an exhaust passage, press-fitted into the outer housing cylinder.

Further, a press-fitting apparatus for press-fitting a ceramic catalyst carrier into an outer housing cylinder according to the present invention is characterized in that it includes a press-forming jig configured to evenly press in a radial direction an entire outer peripheral surface of the non-expandable mat assembled on an outer periphery of a ceramic catalyst carrier and press form an contour of the non-expandable mat to be close to an inner diameter of the outer housing cylinder constituting a part of an exhaust passage; and a press-fitting unit configured to press-fit the ceramic catalyst carrier with the non-expandable mat being press formed by the press-forming jig into the outer housing cylinder.

Preferably, the press-fitting apparatus is characterized in that the press-forming jig includes a partly cut cylindrical pressing member constituted of divided pressing pieces plurally divided in a circumferential direction along the outer periphery of the non-expandable mat, an outer cylinder covering the outer periphery of the partly cut cylindrical pressing member, and a radial pressing member configured to evenly press in a radial direction the entire outer periphery of the non-expandable mat to press form the contour of the non-expandable mat to be close to the inner diameter of the outer housing cylinder by press-fitting into a space between the outer cylinder and the partly cut cylindrical pressing member.

Preferably, the press-fitting apparatus is characterized in that both side edges on an inner-diameter side of each of the divided pressing pieces are chamfered in an arc shape or a taper shape.

Preferably, the press-fitting apparatus is characterized in that at the time when the press-forming of the non-expandable mat by using the press-forming jig is completed, a predetermined gap is maintained between cutout portions of adjacent divided pressing pieces.

Preferably, the press-fitting apparatus is characterized in that the predetermined gap maintained between the cutout portions of adjacent divided pressing pieces is set in the range from the same as the thickness of the non-expandable mat to ½ of the thickness after the press-forming.

Preferably, the press-fitting apparatus is characterized in that a cylindrical guide configured to guide a ceramic catalyst carrier in which the non-expandable mat is press formed by using the press-forming jig to the outer housing cylinder is provided integrally at an exit side of the radial pressing member, and that the press-fitting unit is configured to press-fit the ceramic catalyst carrier in which the non-expandable mat is press-formed by the press-forming jig via the cylindrical guide into the outer housing cylinder arranged on an exit side of the cylindrical guide.

Preferably, the press-fitting apparatus is characterized in that the inner diameter of the cylindrical guide is formed to be larger than the inner diameter of the partly cut cylindrical pressing member at the time when the press-forming is completed.

Preferably, the press-fitting apparatus is characterized in that an exit side opening edge of the partly cut cylindrical pressing member is chamfered in an arc shape or a taper shape.

Preferably, the press-fitting apparatus is characterized in that at least one of the exit side opening edge of the partly cut cylindrical pressing member and an entrance side opening edge of the cylindrical guide is chamfered in an arc shape or a taper shape.

Preferably, the press-fitting apparatus is characterized in that according to dispersion of the outer diameter of the ceramic catalyst carrier with the non-expandable mat being wrapped thereon, the outer diameter value of the ceramic catalyst carrier is fed back for controlling a radial direction pressing stroke amount of the partly cut cylindrical pressing member in the press-forming jig.

### EFFECT OF THE INVENTION

In the above-described press-fitting method for press-fitting the ceramic catalyst carrier with the non-expandable mat being wrapped thereon into the outer housing cylinder, a ceramic catalyst carrier with a non-expandable mat being assembled on an outer periphery thereof is, after first the entire outer peripheral surface of the non-expandable mat is evenly pressed in a radial direction and the contour thereof is press formed to be close to the inner diameter of an outer housing cylinder constituting a part of an exhaust passage, press-fitted into the outer housing cylinder, so that the compressing force and shearing force in plural directions will not be applied simultaneously when the non-expandable mat is compressed. Therefore, the effect of preventing problems such as displacement, damage and the like of the non-expandable mat during press-fitting of the ceramic catalyst carrier into the outer housing cylinder can be achieved.

Further, the above-described press-fitting apparatus for press-fitting the ceramic catalyst carrier with the non-expandable mat being wrapped thereon into the outer housing cylinder includes a press-forming jig configured to evenly press in a radial direction the entire outer peripheral surface of a non-expandable mat assembled on the outer periphery of a ceramic catalyst carrier and press form the contour thereof to be close to the inner diameter of an outer housing cylinder constituting a part of an exhaust passage, and a press-fitting unit configured to press-fit the ceramic catalyst carrier with the non-expandable mat being press formed by the press-forming jig into the outer housing cylinder, so that the compressing force and shearing force in plural directions will not be applied simultaneously when the non-expandable mat is compressed. Therefore, the effect of preventing problems such as displacement, damage and the like of the non-expandable mat during press-fitting of the ceramic catalyst carrier into the outer housing cylinder can be achieved.

In the above-described press-fitting apparatus, the press-forming jig includes a partly cut cylindrical pressing member constituted of divided pressing pieces plurally divided in a circumferential direction along the outer periphery of the non-expandable mat, an outer cylinder covering the outer periphery of the partly cut cylindrical pressing member, and a radial pressing member configured to evenly press in a radial direction the entire outer periphery of the non-expandable mat to press form the contour thereof to be close to the inner diameter of the outer housing cylinder by press-fitting into a space between the outer cylinder and the partly cut cylindrical pressing member, so that merely the driving operation of the outer cylinder and the radial pressing member in a direction to come close to each other in the axial direction allows to evenly press the entire outer peripheral surface of the non-expandable mat in the radial direction to thereby press form the contour thereof easily to be close to the inner diameter of the outer housing cylinder.

In the above-described press-fitting apparatus, both side edges on an inner diameter side of each of the divided pressing pieces are chamfered in an arc shape or a taper shape, so that pinching of the non-expandable mat between cutout portions of adjacent divided pressing pieces during the press-forming can be suppressed.

In the above-described press-fitting apparatus, at the time when the press-forming of the non-expandable mat by the press-forming jig is completed, a predetermined gap is maintained between cutout portions of adjacent divided pressing pieces, so that pinching of the non-expandable mat between cutout portions of adjacent divided pressing pieces during the press-forming can be prevented.

In the above-described press-fitting apparatus, the predetermined gap maintained between the cutout portions of adjacent divided pressing pieces is set in the range from the same as the thickness of the non-expandable mat to ½ of the thickness after the press-forming, so that pinching of the non-expandable mat between cutout portions of adjacent divided pressing pieces during the press-forming can be surely prevented.

In the above-described press-fitting apparatus, a cylindrical guide configured to guide a ceramic catalyst carrier in which the non-expandable mat is press formed by the press-forming jig to the outer housing cylinder is provided integrally at a lower portion of the radial pressing member, and the press-fitting unit is configured to press-fit the ceramic catalyst carrier in which the non-expandable mat is press formed by the press-forming jig via the cylindrical guide into the outer housing cylinder arranged thereunder, so that the ceramic catalyst carrier in which the non-expandable mat is press formed can be precisely guided to the opening portion of the outer housing cylinder and smoothly press-fitted into the outer housing cylinder, thereby increasing the operating efficiency.

In the above-described press-fitting apparatus, the inner diameter of the cylindrical guide is formed to be slightly larger than the inner diameter of the partly cut cylindrical pressing member at the time when the press-forming is completed, so that the interference of the upper opening edge of the cylindrical guide with the non-expandable mat when the ceramic catalyst carrier in which the non-expandable mat is press formed is delivered into the cylindrical guide can be suppressed. Therefore, the ceramic catalyst carrier can be smoothly delivered into the cylindrical guide without deforming the non-expandable mat.

In the above-described press-fitting apparatus, an exit side opening edge of the partly cut cylindrical pressing member is chamfered in an arc shape or a taper shape, so that the catalyst carrier can be smoothly delivered into the cylindrical guide.

In the above-described press-fitting apparatus, at least one of the exit side opening edge of the partly cut cylindrical pressing member and an entrance side opening edge of the cylindrical guide is chamfered in an arc shape or a taper shape, so that the ceramic catalyst carrier can be more smoothly delivered into the cylindrical guide.

In the above-described press-fitting apparatus, according to dispersion of the outer diameter of the ceramic catalyst carrier with the non-expandable mat being wrapped thereon, an outer diameter value thereof is fed back for controlling a radial direction pressing stroke amount of the partly cut cylindrical pressing member in the press-forming jig, so that the compressing amount of the non-expandable mat can be controlled to be constant even when the dispersion of the outside diameter of the ceramic catalyst carrier is large.

### BRIEF DESCRIPTION OF THE DRAWINGS

FIG. 1 is a front view showing a press-fitting apparatus of an example 1 for press-fitting the ceramic catalyst carrier with a non-expandable mat being wrapped thereon into the outer housing cylinder;

FIG. 2 is a right side view showing the press-fitting apparatus of the example 1;

FIG. 3 is a plan view showing the ceramic catalyst carrier with the non-expandable mat being wrapped thereon and a press-forming jig housing them in the press-forming apparatus of the example 1 in a state before performing press-forming;

FIG. 4 is a vertical cross-sectional view showing the ceramic catalyst carrier with the non-expandable mat being wrapped thereon and the press-forming jig of FIG. 3 in the state before performing the press-forming;

FIG. 5 is a plan view showing the ceramic catalyst carrier with the non-expandable mat being wrapped thereon and the press-forming jig housing them in the press-forming apparatus of the example 1 in a state after performing the press-forming;

FIG. 6 is a vertical cross-sectional view showing the press-forming jig and the ceramic catalyst carrier with the non-expandable mat being wrapped thereon in the state after performing the press-forming of FIG. 5;

FIG. 7 is a partly enlarged view showing a relationship of a gap between respective divided pressing pieces of the press-forming jig with a thickness of the non-expandable mat after performing the press-forming, in which (a) shows opening edges of a partly cut cylindrical pressing member and a cylindrical guide both formed in an arc shape, (b) shows the opening edge of the partly cut cylindrical pressing member formed in an arc shape and the opening edge of the cylindrical guide formed in a taper shape, and (c) shows the opening edge of the partly cut cylindrical pressing member formed in a taper shape and the opening edge of the cylindrical guide formed in an arc shape;

FIG. 8 is a view showing a relationship of an inner diameter of the partly cut cylindrical pressing member of the press-forming jig with an inner diameter of the cylindrical guide at the time when press-forming is completed;

FIG. 9 is a flowchart showing a press-fitting method for press-fitting the ceramic catalyst carrier into the outer housing cylinder using the press-fitting apparatus of the example 1;

FIG. 10 is an explanatory view showing the operation and effect of the press-fitting method and apparatus for press-fitting the ceramic catalyst carrier into the outer housing cylinder using the press-fitting apparatus of the example 1, in which (a) is a view showing a press-fitting state of the ceramic catalyst carrier with the non-expandable mat being wrapped thereon inside the divided pressing pieces, and (b) is a view showing a press-fitting state of the ceramic catalyst carrier with the non-expandable mat being wrapped thereon into the outer housing cylinder;

FIG. 11 is an explanatory view showing a relationship of an inner diameter of a partly cut cylindrical pressing member with an inner diameter of a cylindrical guide at the time when press-forming is completed in a press-forming apparatus of an example 2 for press-forming a ceramic catalyst carrier with a non-expandable mat being wrapped thereon into an outer housing cylinder;

FIG. 12 is an explanatory showing a press-fitting method and apparatus for press-fitting a ceramic catalyst carrier with a non-expandable mat being wrapped thereon into an outer housing cylinder of a conventional example;

FIG. 13 is an explanatory view showing problems of the conventional example, in which (a) is a view showing a state of external forth affecting the non-expandable mat when the ceramic catalyst carrier with the non-expandable mat being wrapped thereon is inserted into a press-fitting guide jig and (b) is a view showing a deformation state of the non-expandable mat when the ceramic catalyst carrier with the non-expandable mat being wrapped thereon is inserted into the press-fitting guide jig; and

FIG. 14 is an explanatory view showing problems of the conventional example, in which (a) is a view showing a deformation state of the non-expandable mat of the ceramic catalyst carrier when being press-fitted into the outer housing cylinder and (b) is a view showing another deformation state of the non-expandable mat of the ceramic catalyst carrier when being press-fitted into the outer housing cylinder.

### BEST MODE FOR CARRYING OUT THE INVENTION

Hereinafter, examples of the present invention will be described based on the drawings.

### EXAMPLE 1

First, a press-fitting method and apparatus for press-fitting a ceramic catalyst carrier with a non-expandable mat being wrapped thereon into an outer housing cylinder according to an example 1 of the present invention will be described based on the drawings.

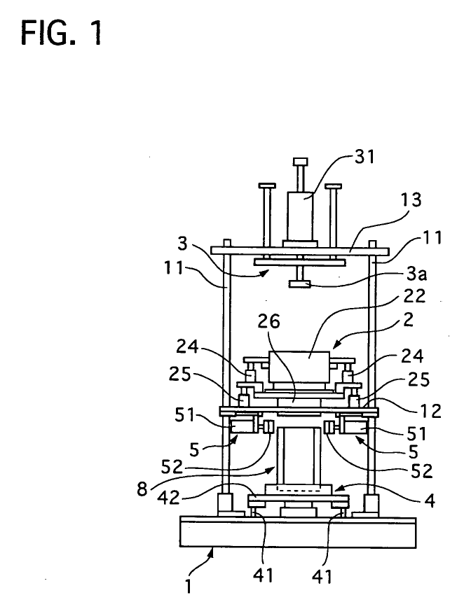

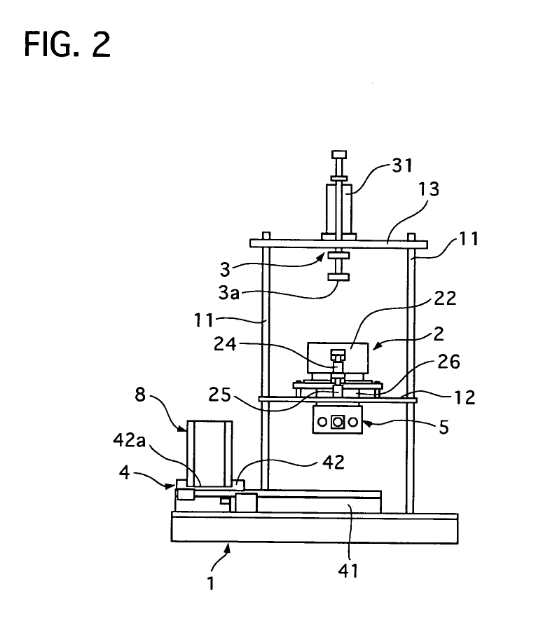

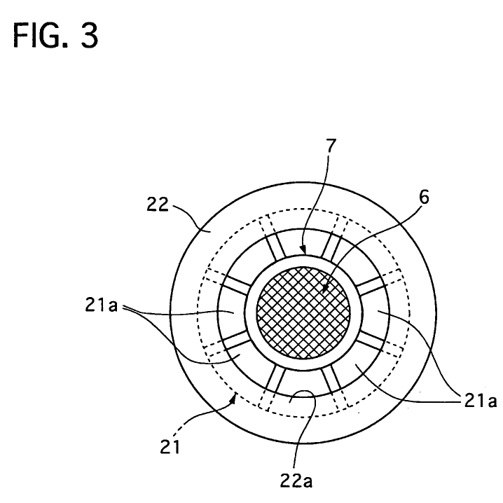

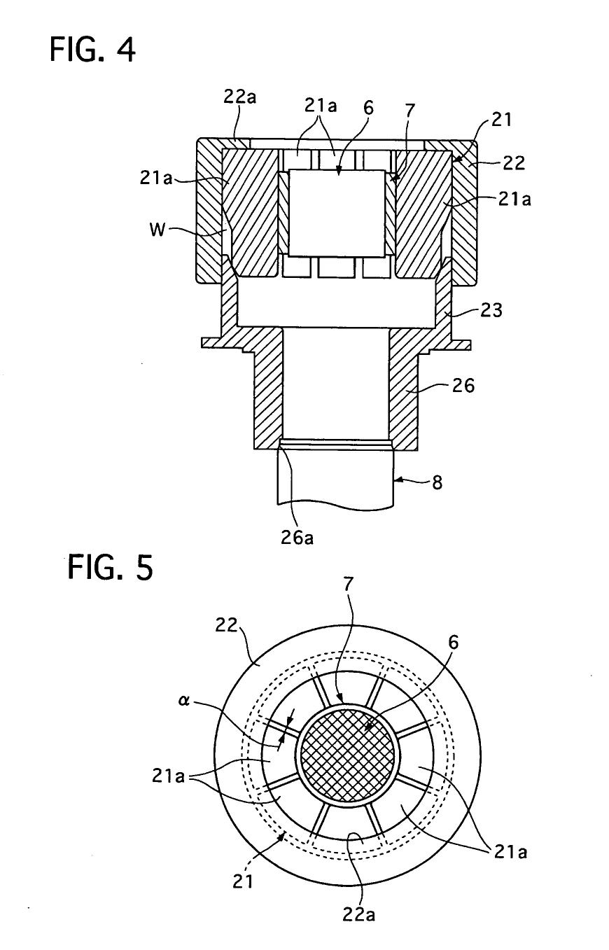

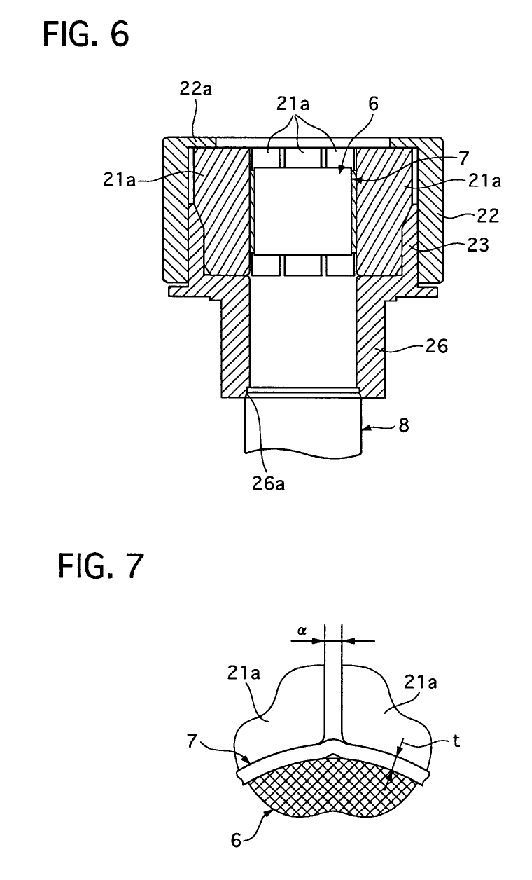

FIG. 1 is a front view showing the press-fitting apparatus of the example 1 for press-fitting the ceramic catalyst carrier with the non-expandable mat being wrapped thereon into the outer housing cylinder (hereinafter, referred to as a press-fitting apparatus), FIG. 2 is a right side view of the press-fitting apparatus of FIG. 1, FIG. 3 is a plan view showing a press-forming jig housing the ceramic catalyst carrier with the non-expandable mat being wrapped thereon in a state before performing press-forming, FIG. 4 is a vertical cross-sectional view of the press-forming jig of FIG. 3 in the state before performing the press-forming, FIG. 5 is a plan view showing the press-forming jig in a state after performing the press-forming, and FIG. 6 shows a vertical cross-sectional view of the press-forming jig of FIG. 5 in the state after performing the press-forming.

The press-fitting apparatus in this example has a base 1, a press-forming jig 2, a press-fitting unit 3, an outer housing cylinder holding/transporting unit 4, and an outer housing cylinder positioning/holding unit 5.

To described more specifically, as shown in FIG. 3 to FIG. 6, the press-forming jig 2 serves to evenly press in a radial direction the entire outer peripheral surface of a non-expandable mat 7 assembled on the outer periphery of a ceramic catalyst carrier 6, and press-forming an outer edge thereof to be close to the inner diameter of an outer housing cylinder 8 constituting a part of an exhaust passage. This press-forming jig 2 is, as shown in FIG. 1 and FIG. 2, assembled on an upper surface side of an intermediate support table 12 supported on intermediate positions of four outer frames 11 arranged upright on the base 1.

As shown in FIG. 3 to FIG. 6 in detail, this press-forming jig 2 is constituted of a partly cut cylindrical pressing member 21 constituted of divided pressing pieces 21a divided into eight pieces in a circumferential direction along the outer periphery of the non-expandable mat 7, an outer cylinder 22 covering the outer periphery of the partly cut cylindrical pressing member 21, and a radial pressing member 23 configured to evenly press in a radial direction the entire outer periphery of the non-expandable mat 7 to press form the contour thereof to be close to the inner diameter of the outer housing cylinder 8 by press-fitting into a space between the outer cylinder 22 and the partly cut cylindrical pressing member 21.

Specifically, the outer cylinder 22 has an inward blocking flange 22a formed to protrude from an upper end opening edge thereof, which comes in contact with the outer peripheral portion of an upper end surface of each divided pressing piece 21a and blocks it, thereby preventing upward disengagement thereof.

Then, the outer periphery of an exit side portion of the partly cut cylindrical pressing member 21 constituted of the eight divided pressing pieces 21a is formed to have a smaller diameter than an entrance side outer peripheral portion thereof, so that an annular gap W can be formed between the outer periphery of the exit side portion and an inner peripheral side portion of the outer cylinder 22. Into this annular gap W, the radial pressing member 23 formed in a cylinder having a wedge shaped cross section, whose upper inner side portion is in a taper shape, is press-fitted, so that the wedge effect therebetween reduces the diameter of the partly cut cylindrical pressing member 21 as shown in FIG. 5 and FIG. 6. Further, when the radial pressing member 23 disengages from the annular gap W by a spring or the like, the partly cut cylindrical pressing member 2 expands in diameter.

Further, the press-fitting apparatus is configured to maintain, at the time when the press-forming of the non-expandable mat 7 by the press-forming jig 2 is completed, a predetermined circumferential direction gap α between cutout portions of adjacent divided pressing pieces 21a, 21a as shown in FIG. 5. Then, as shown in FIG. 7, this circumferential direction gap α is set in the range from the same as the thickness t of the non-expandable mat 7 to ½ of the thickness t (t/2≦α≦t) after press-forming. Incidentally, both side edges on the inner diameter side of each of the divided pressing pieces 21a are chamfered in an arc shape.

Referring back to FIG. 1 and FIG. 2, driving operation of press-fitting the radial pressing member 23 is performed by a pair of first hydraulic cylinders 24, 24 interposed between the radial pressing member 23 and the outer cylinder 22. Further, the press-forming jig 2 is supported by a pair of second hydraulic cylinders 25, 25 in a state capable to be driven upward and downward with respect to the intermediate support table 12.

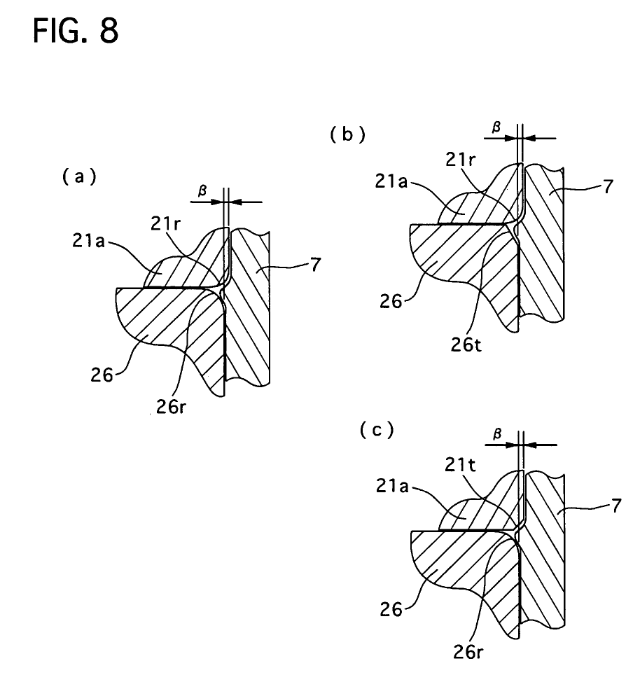

Further, on the exit side of the radial pressing member 23, a cylindrical guide which guides the ceramic catalyst carrier 6 in which the non-expandable mat 7 is press formed by the press-forming jig 2 to the outer housing cylinder 8 is integrally provided. The inner diameter of this cylindrical guide 26 is formed to be slightly (approximately 1 mm) larger than the inner diameter of the partly cut cylindrical pressing member 21 at the time when the press-forming is completed as shown in FIG. 5 and FIG. 6 (refer to FIG. 8(a)), and a lower end opening edge 21r of the partly cut cylindrical pressing member 21 and the upper end opening edge 26r of the cylindrical guide 26 are both chamfered in an arc shape. Alternatively, as shown in FIG. 8(b), the lower end opening edge 21r of the partly cut cylindrical pressing member 21 may be formed in an arc shape and the upper end opening edge 26t of the cylindrical guide 26 may be formed in a taper shape, or the lower end opening edge 21t of the partly cut cylindrical pressing member 21 may be formed in a taper shape and the upper end opening edge 26r of the cylindrical guide 26 may be formed in an arc shape.

The press-fitting unit 3 serves to press-fit the ceramic catalyst carrier 6 in which the non-expandable mat 7 is press formed by the press-forming jig 2 into the outer housing cylinder 8 via the inside of the cylindrical guide 26, and is provided on an upper support table 13 supported on upper end portions of the four outer frames 11. This press-fitting unit 3 is configured to press the ceramic catalyst carrier 6 by driving a pressing piece 3a upward and downward by a third hydraulic cylinder 31.

The outer housing cylinder holding/transporting unit 4 is constructed such that, on a holding part 42 provided in a state capable of being transported along rails 41 provided in a forward and backward direction on a top surface center portion of the base 1, a recess 42a into which a lower end opening edge of the outer housing cylinder 8 can be fitted is formed, and the outer housing cylinder 8 can be retained in a perpendicularly standing state.

The outer housing cylinder positioning/holding unit 5 serves to position and secure the outer housing cylinder 8, which is transported by the outer housing cylinder holding/transporting unit 4 to immediately under the cylindrical guide 26, to a fixed position by holding an upper end portion thereof, and has sandwiching pieces 52, 52 provided on an under side of the intermediate support table 12 and configured to be driven back and forth in a horizontal direction by a pair of fourth hydraulic cylinders 51, 51.

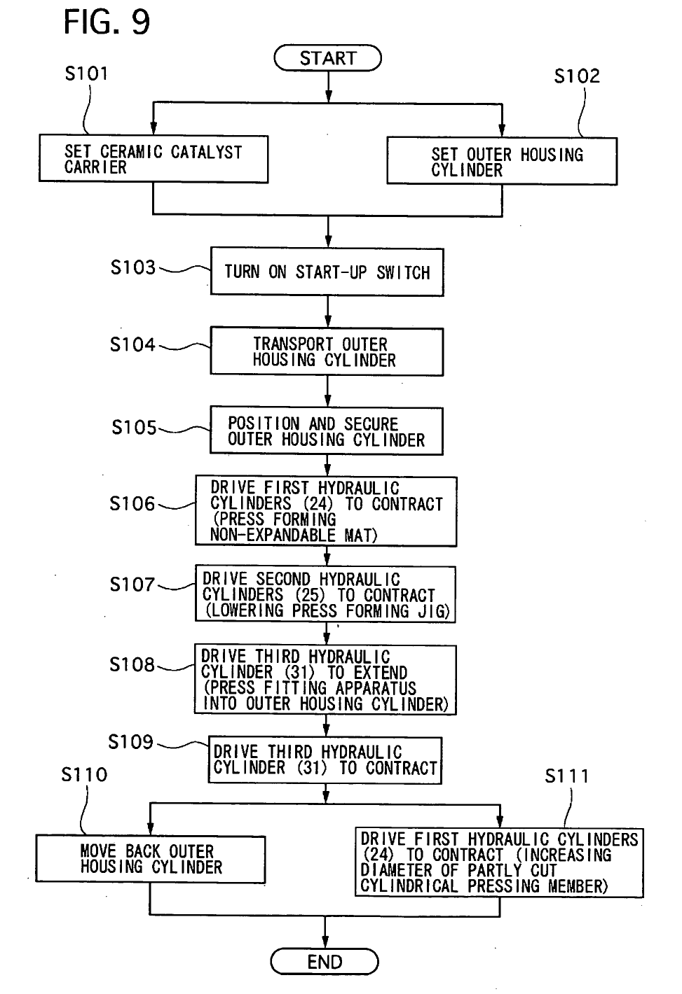

Next, the press-fitting method for press-fitting the ceramic catalyst carrier 6 into the outer housing cylinder 8 using the press-fitting apparatus of the example 1 will be described based on a flowchart of FIG. 9.

With this press-fitting apparatus of the example 1 configured as described above, press-fitting of the ceramic catalyst carrier 6 into the outer housing cylinder 8 is performed in the following order.

First, as shown in FIG. 3 and FIG. 4, the ceramic catalyst carrier 6 with the non-expandable mat 7 being assembled on the outer periphery thereof is set in a hollow portion of the partly cut cylindrical pressing member 21 constituted of the divided pressing pieces 21a divided into eight pieces (step S101), and on the other hand, the lower end opening edge of the outer housing cylinder 8 is inserted into the recess 42a formed on an upper surface of the holding part 42 of the outer housing cylinder holding/transporting unit 4, thereby setting the outer housing cylinder in a perpendicularly standing state (step S102).

Next, when a start-up switch is turned on (step S103), the outer housing cylinder holding/transporting unit 4 is driven so that the holding part 42 with the outer housing cylinder 8 being set thereon is moved forward along the rails 41 and transported to immediately under the cylindrical guide 26 (step S104). Subsequently, the outer housing cylinder positioning/holding unit 5 is driven so that the sandwiching pieces 52, 52 are driven inward in the horizontal direction by the pair of fourth hydraulic cylinders 51, 51 so as to sandwich a ceramic catalyst carrier entrance portion of the outer housing cylinder 8, thereby positioning and securing the outer housing cylinder 8 at a fixed position (step S105).

Next, the pair of first hydraulic cylinders 24, 24 interposed between the radial pressing member 23 and the outer cylinder 22 are driven in a contracting direction to thereby lower the outer cylinder 22 with the partly cut cylindrical pressing member 21 and the ceramic catalyst carrier 6 (step S106). Then, as shown in FIG. 5 and FIG. 6, into the annular gap W formed between a lower side outer peripheral surface formed at a small diameter portion of the partly cut cylindrical pressing member 21 and an inner periphery side surface of the outer cylinder 22 (refer to FIG. 4), the radial pressing member 23 constituted of a cylinder having a wedge shaped cross section, whose front inner side is formed in a taper shape, is press-fitted. Consequently, by the wedge effect of the taper shape, the partly cut cylindrical pressing member 21 is pressed to move in a direction to be reduced in diameter so as to evenly press the entire outer peripheral surface of the non-expandable mat 7 toward the radial direction, and as a result, the outer periphery thereof is in a state of being press formed to be close to the inner diameter of the outer housing cylinder 8.

Next, the pair of second hydraulic cylinders 25, 25 are driven in a contracting direction to thereby move the entire press-forming jig 2 in a direction toward the outer housing cylinder 8 (step S107), an entrance side opening edge of the outer housing cylinder 8 is fitted into a large diameter portion 26a formed at an exit side opening edge of the cylindrical guide 26, which is provided integrally at an exit side of the radial pressing member 23, to thereby become a coupled state.

Next, the press-fitting unit 3 is driven. Specifically, when the third hydraulic cylinder 31 is driven in an extending direction so that the pressing piece 3a is moved in a direction toward the outer housing cylinder 8 (step S108), the pressing piece 3a moves the ceramic catalyst carrier 6, in which the non-expandable mat 7 is press formed by the press-forming jig 2, into the outer housing cylinder 8 via the cylindrical guide 26, thereby press-fitting the ceramic catalyst carrier 6 into the outer housing cylinder 8.

Next, the pressing piece 3a is raised by driving the third hydraulic cylinder 31 in a contracting direction (step S109), and the second hydraulic cylinders 25, 25 are driven in an extending direction, thereby releasing the coupling state of the outer housing cylinder 8 with the cylindrical guide 26.

Next, by the outer housing cylinder retaining/transporting unit 4, the holding part 42 is moved back to its original position along the rails 41 (step S110), and the outer housing cylinder 8 in which the ceramic catalyst carrier 7 is press-fitted is removed from the holding part 42. On the other hand, the pair of first hydraulic cylinders 24, 24 interposed between the radial pressing member 23 and the outer cylinder 22 is driven in an extending direction so as to raise the outer cylinder 22 with the partly cut cylindrical pressing member 21 (step S111). Then, as shown in FIG. 3 and FIG. 4, the press-fitting state of the radial pressing member 23 with respect to the annular gap W formed between the lower side outer peripheral surface formed at the small diameter portion of the partly cut cylindrical pressing member 21 and the inner peripheral surface of the outer cylinder 22 is released, so that the partly cut cylindrical pressing member 21 returns to its original state of having an extended diameter, which allows the next operation to be performed.

Next, the operation and effect of this example 1 will be described.

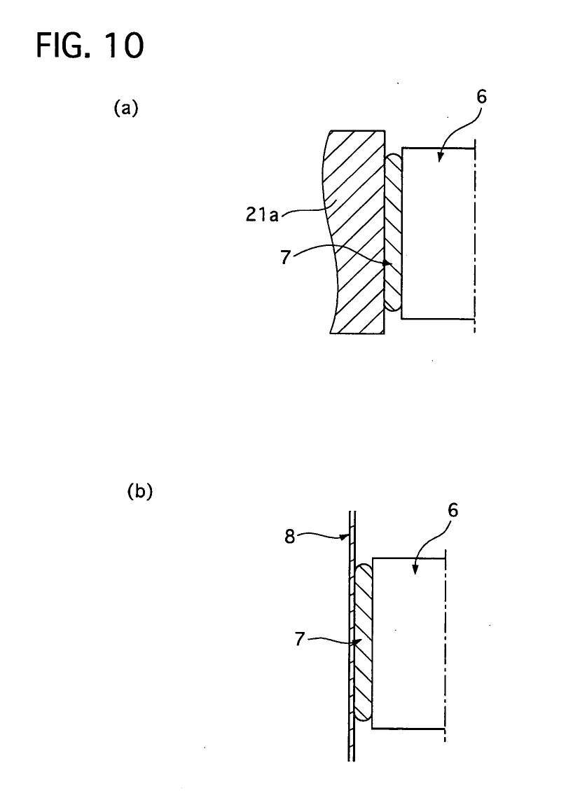

In the press-fitting method and apparatus for press-fitting the ceramic catalyst carrier with the non-expandable mat being wrapped thereon into the outer housing cylinder according to this example 1, as described above, the ceramic catalyst carrier 6 with the non-expandable mat 7 being assembled on the outer periphery thereof is, after first the entire outer peripheral surface of the non-expandable mat 7 is evenly pressed in the radial direction by the press-forming jig 2 and the contour thereof is press formed to be close to the inner diameter of the outer housing cylinder 8 constituting a part of an exhaust passage, press-fitted into the outer housing cylinder 8 by the press-fitting unit 3, so that the compressing force and shearing force in plural directions will not be applied simultaneously when the non-expandable mat 7 is compressed. Therefore, in the present press-fitting method and apparatus, the non-expandable mat 7 is in a state shown in FIG. 10, which provides the effect of preventing problems such as displacement, damage and the like of the non-expandable mat 7 during press-fitting of the ceramic catalyst carrier 6 into the outer housing cylinder 8.

Further, the press-forming jig 2 is constituted of the partly cut cylindrical pressing member 21 constituted of the divided pressing pieces 21 a plurally divided in the circumferential direction along the outer periphery of the non-expandable mat 7, the outer cylinder 22 covering the outer periphery of the partly cut cylindrical pressing member 21, and the radial pressing member 23 evenly pressing in the radial direction the entire outer peripheral surface of the non-expandable mat 7 to press form the contour thereof to be close to the inner diameter of the outer housing cylinder 8 by press-fitting into the space between the outer cylinder 22 and the partly cut cylindrical pressing member 21, so that merely the driving operation of the outer cylinder 22 and the radial pressing member 23 in a direction to come close to each other in the axial direction by the first hydraulic cylinders 24, 24 allows to evenly press the entire outer peripheral surface of the non-expandable mat 7 in the radial direction to thereby press form the contour thereof easily to be close to the inner diameter of the outer housing cylinder 8.

Further, the both side edges on the inner diameter side of each of the divided pressing pieces 21a are chamfered in an arc shape or a taper shape as shown in FIG. 7, so that pinching of the non-expandable mat 7 between cutout portions of adjacent divided pressing pieces 21a, 21a during press-forming can be suppressed.

Further, at the time when the press-forming of the non-expandable mat 7 by the press-forming jig 2 is completed, as shown in FIG. 7, a predetermined circumferential direction gap a is maintained between cutout portions of adjacent divided pressing pieces 21a, 21a, and this circumferential direction gap α is set in the range from the same as the thickness t of the non-expandable mat 7 to ½ of the thickness after press-forming, so that pinching of the non-expandable mat 7 between cutout portions of adjacent divided pressing pieces 21a, 21a during press-forming can be surely prevented.

Further, the cylindrical guide 26 configured to guide a ceramic catalyst carrier in which the non-expandable mat 7 is press formed by the press-forming jig 2 to the outer housing cylinder 8 is provided integrally at the lower portion of the radial pressing member 23, and the press-fitting unit 3 is configured to press-fit the ceramic catalyst carrier 6 in which the non-expandable mat 7 is press formed by the press-forming jig 2 via the cylindrical guide 26 into the outer housing cylinder 8 arranged thereunder, so that the ceramic catalyst carrier 6 in which the non-expandable mat 7 is press formed can be precisely guided to the opening portion of the outer housing cylinder 8 and smoothly press-fitted into the outer housing cylinder 8, thereby increasing the operating efficiency.

Further, the inner diameter of the cylindrical guide 26 is, as shown in FIG. 8, formed to be slightly larger than the inner diameter of the partly cut cylindrical pressing member 21 at the time when the press-forming is completed, so that the interference of the upper opening edge of the cylindrical guide 26 with the non-expandable mat 7 when the ceramic catalyst carrier 6 in which the non-expandable mat 7 is press formed is delivered into the cylindrical guide 26 can be suppressed, thereby allowing smooth delivery of the ceramic catalyst carrier 6 into the cylindrical guide 26 without deforming the non-expandable mat 7.

Further, the lower end opening edge of the partly cut cylindrical pressing member 21 and the upper end opening edge of the cylindrical guide 26 are, as shown in FIG. 8, chambered in an arc shape, so that the ceramic catalyst carrier 6 can be more smoothly delivered into the cylindrical guide 26.

Next, another example will be described. In this description of another example, the same components as those in the above-described example 1 will be omitted in the drawings or designated the same reference numerals so as to omit the description thereof, and only differences will be described.

### EXAMPLE 2

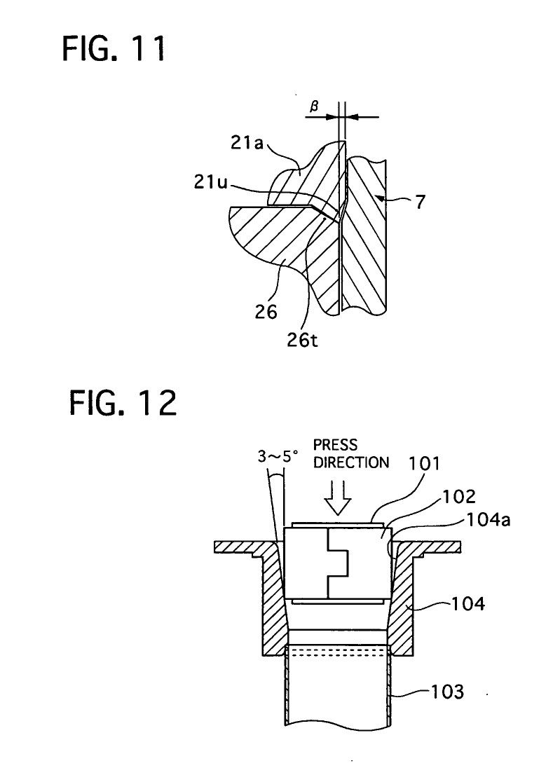

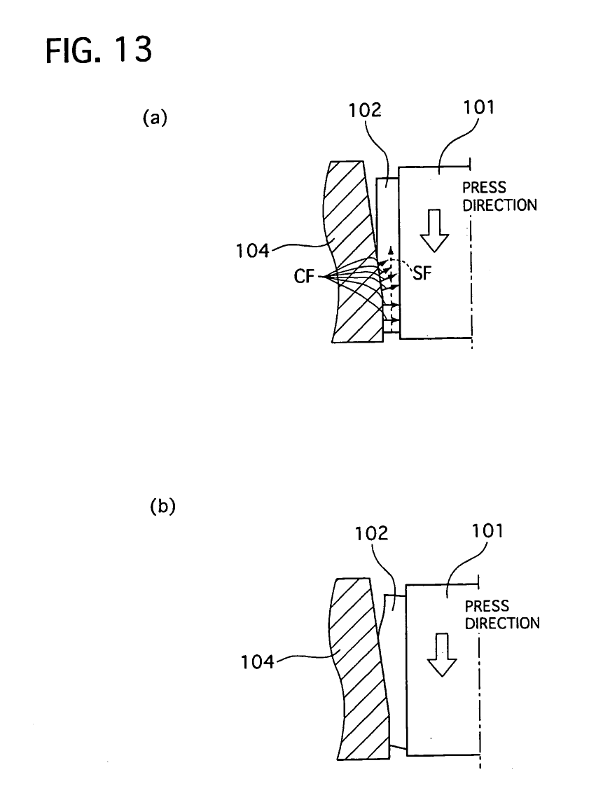

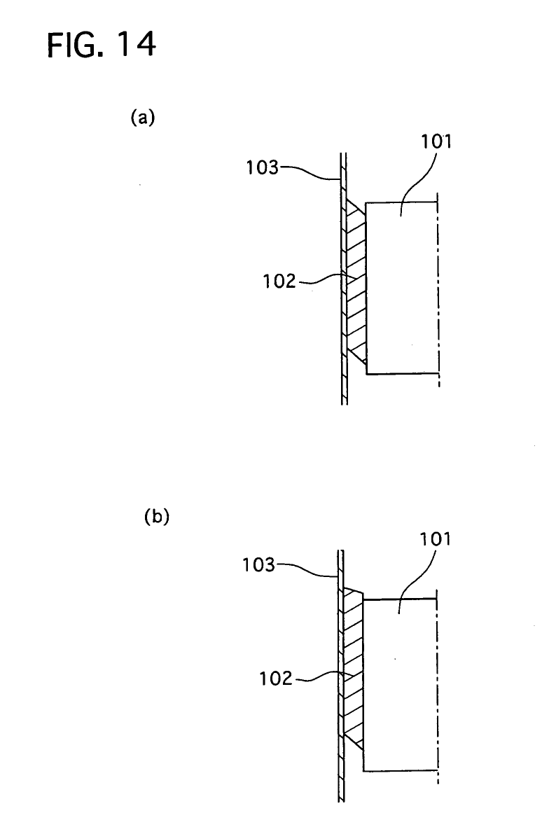

FIG. 11 is an explanatory view showing a relationship between the inner diameter of a partly cut cylindrical pressing member and the inner diameter of a cylindrical guide at the time when the press-forming is completed in the case of using a press-fitting method and apparatus of the example 2 for press-fitting a ceramic catalyst carrier with a non-expandable mat being wrapped thereon into an outer housing cylinder. As shown in the view, in this example 2, an entrance side opening edge 26t of the cylindrical guide 26 is chamfered in a taper shape, while an exit side opening edge 21u of the divided pressing piece 21a of the partly cut cylindrical pressing member 21 is projected downward along the taper surface, and this exit side opening edge 21u is chamfered in a taper shape to correspond with the inner diameter of the cylindrical guide 26. Further, the inner peripheral surface of the divided pressing piece 21a is made smaller by dimension β in a radial direction than the inner peripheral surface of the cylindrical guide 26, and the exit side opening edge 21u of the divided pressing piece 21a is chamfered in a taper shape and the tip thereof is formed to be connected to the inner peripheral surface of the cylindrical guide 26. Thus, a gap cannot be formed between the exit side opening edge 2u of the partly cut cylindrical pressing member 21 and the entrance side opening edge 26t of the cylindrical guide 26, and the non-expandable mat 7 can be moved from the partly cut cylindrical pressing member via the cylindrical guide portion 26 to the outer housing cylinder while the diameter of the non-expandable mat 7 is slightly expanded, which are the differences of the example 2 from the example 1. Therefore, in this example 2, the ceramic catalyst carrier 6 can be more smoothly delivered into the cylindrical guide 26.

In the foregoing, the present example has been described, but the present invention is not limited to the above-described examples and variations in design and the like in the range not departing from the gist of the present invention will be included in the present invention.

For instance, in the examples, hydraulic cylinders are used as actuators, but air cylinders, motors, and the like may be used.

Further, according to dispersion of the outer diameter of the ceramic catalyst carrier 6 with the non-expandable mat 7 being wrapped thereon, an outer diameter value thereof may be fed back for controlling a radial direction pressing stroke amount of the partly cut cylindrical pressing member 21 in the press-forming jig 2, which enables control of the compressing amount of the non-expandable mat 7 to be constant even when the dispersion of the outside diameter of the ceramic catalyst carrier 6 is large.

### Industrial Availability

The press-fitting method and press-fitting apparatus according to the present invention for press-fitting a ceramic catalyst carrier with a non-expandable mat being wrapped thereon into an outer housing cylinder are suitable for a press-fitting method and press-fitting apparatus and the like for press-fitting a catalyst carrier into an outer housing cylinder, which are configured to press-fit ceramic catalyst carrier with a non-expandable mat being wrapped on the outer surface thereof into an outer housing cylinder of a catalyst unit used in the exhaust system of a vehicle internal combustion engine or the like.

1. A press-fitting method for press-fitting a ceramic catalyst carrier with a non-expandable mat being wrapped thereon into an outer housing cylinder, wherein the ceramic catalyst carrier with the non-expandable mat being assembled on an outer periphery thereof is, after an entire outer peripheral surface of the non-expandable mat is evenly pressed in a radial direction and an contour of the non-expandable mat is press formed to be close to an inner diameter of an outer housing cylinder constituting a part of an exhaust passage, press-fitted into the outer housing cylinder.

2. A press-fitting apparatus for press-fitting a ceramic catalyst carrier with a non-expandable mat being wrapped thereon into an outer housing cylinder, comprising: a press-forming jig configured to evenly press in a radial direction an entire outer peripheral surface of a non-expandable mat assembled on an outer periphery of the ceramic catalyst carrier and press form an contour of the non-expandable mat to be close to an inner diameter of an outer housing cylinder constituting a part of an exhaust passage; and a press-fitting unit configured to press-fit the ceramic catalyst carrier with the non-expandable mat being press formed by said press-forming jig into the outer housing cylinder.

3. The press-fitting apparatus for press-fitting the ceramic catalyst carrier with the non-expandable mat being wrapped thereon into the outer housing cylinder according to claim 2, wherein said press-forming jig comprises: a partly cut cylindrical pressing member constituted of divided pressing pieces plurally divided in a circumferential direction along the outer periphery of the non-expandable mat; an outer cylinder covering the outer periphery of said partly cut cylindrical pressing member; and a radial pressing member configured to evenly press in a radial direction the entire outer periphery of the non-expandable mat to press form the contour of the non-expandable mat to be close to the inner diameter of the outer housing cylinder by press-fitting into a space between said outer cylinder and said partly cut cylindrical pressing member.

4. The press-fitting apparatus for press-fitting the ceramic catalyst carrier with the non-expandable mat being wrapped thereon into the outer housing cylinder according to claim 3, wherein both side edges on an inner diameter side of each of the divided pressing pieces are chamfered in an arc shape or a taper shape.

5. The press-fitting apparatus for press-fitting the ceramic catalyst carrier with the non-expandable mat being wrapped thereon into the outer housing cylinder according to claim 3, wherein at the time when the press-forming of the non-expandable mat by using said press-forming jig is completed, a predetermined gap is maintained between cutout portions of adjacent divided pressing pieces.

6. The press-fitting apparatus for press-fitting the ceramic catalyst carrier with the non-expandable mat being wrapped thereon into the outer housing cylinder according to claim 5, wherein the predetermined gap maintained between the cutout portions of adjacent divided pressing pieces is set in the range from the same as the thickness of the non-expandable mat to ½ of the thickness after the press-forming.

7. The press-fitting apparatus for press-fitting the ceramic catalyst carrier with the non-expandable mat being wrapped thereon into the outer housing cylinder according to claim 2, wherein a cylindrical guide configured to guide the ceramic catalyst carrier in which the non-expandable mat is press formed by using said press-forming jig to the outer housing cylinder is provided integrally at an exit side of said radial pressing member, and that said press-fitting unit is configured to press-fit the ceramic catalyst carrier in which the non-expandable mat is press formed by using said press-forming jig via said cylindrical guide into the outer housing cylinder arranged on an exit side of said cylindrical guide.

8. The press-fitting apparatus for press-fitting the ceramic catalyst carrier with the non-expandable mat being wrapped thereon into the outer housing cylinder according to claim 7, wherein the inner diameter of said cylindrical guide is formed to be larger than the inner diameter of said partly cut cylindrical pressing member at the time when the press-forming is completed.

9. The press-fitting apparatus for press-fitting the ceramic catalyst carrier with the non-expandable mat being wrapped thereon into the outer housing cylinder according to claim 7, wherein an exit side opening edge of said partly cut cylindrical pressing member is chamfered in an arc shape or a taper shape.

10. The press-fitting apparatus for press-fitting the ceramic catalyst carrier with the non-expandable mat being wrapped thereon into the outer housing cylinder according to claim 7, wherein at least one of the exit side opening edge of said partly cut cylindrical pressing member and an entrance side opening edge of said cylindrical guide is chamfered in an arc shape or a taper shape.

11. The press-fitting apparatus for press-fitting the ceramic catalyst carrier with the non-expandable mat being wrapped thereon into the outer housing cylinder according to claim 3, wherein according to dispersion of the outer diameter of the ceramic catalyst carrier with the non-expandable mat being wrapped thereon, an outer diameter value of the ceramic catalyst carrier is fed back for controlling a radial direction pressing stroke amount of said partly cut cylindrical pressing member in said press-forming jig.
